(19) United States
(12) Patent Application Publication
(10) Pub. No.: US 2022/0009653 A1
(43) Pub. Date: Jan. 13, 2022

(54) CONTINUOUS MAGNETIC PULSE THRUSTER

(71) Applicant: GUILLERMO ALBERTO MORALES SOLORZANO, Ciudad (MX)

(72) Inventor: GUILLERMO ALBERTO MORALES SOLORZANO, Ciudad (MX)

(21) Appl. No.: 17/294,201

(22) PCT Filed: Nov. 12, 2019
(86) PCT No.: PCT/MX2019/000120

§ 371 Date: May 14, 2021

(30) Foreign Application Priority Data
Nov. 15, 2018 (MX) MX/A/2018/014020

(51) Int. Cl. B64G 1/40; F03G 3/00

(52) U.S. Cl. CPC B64G 1/409; F03G 3/00

(57) ABSTRACT

An improved magnetic pulse thrust device based on inertial propulsion is described; but that it has incorporated a fully magnetic mechanization and that it achieves due in part to its ability to revolutionize its axes of circular motion at a very high number of revolutions per second that increases power and continuity, resulting in a 100% continuous rectilinear motion in a continuous manner, that achieves weightlessness by observing it placed on a scale in a vertical position, thus reducing the gravitational forces of the planets in outer space.

### EXTRACT OF THE INVENTION

An improved magnetic pulse thruster device based on inertial propulsion is described, which essentially increases the continuity in the force vector directed linearly in one direction in such a way that it eliminates 100% any existence of pitch or movement in the opposite direction, specified resultant force vector.

### BACKGROUND OF THE INVENTION

Currently, propulsion systems are based on the thrust made by the thing that moves (cars, planes, boats, bicycles, rockets, etc. . . . ) against the environment (leaning on the environment: soil, water, air or by throwing contained matter in the same thing to propel itself in the opposite direction to the direction of the thrown matter) and achieve the thrust from the contact (friction) that is exerted against the environment; as stated by Newton's first and third laws. Inertial propulsion devices based on mechanical and friction compressions have been made within a closed system structure; but they do not achieve a continuous thrust that it can be visualized on a scale and that shows a stable reading of weight decrease, therefore this new continuous magnetic pulse thruster is intended to be protected by means of the present application.

### OBJECTIVES OF THE INVENTION

The objective of the invented continuous magnetic pulse thruster is a result of the need to achieve movement in space without the use of fuel and only using electrical energy.

### DESCRIPTION OF THE DRAWINGS

FIG. 1 is a top perspective view of the structure of the continuous magnetic drive with transmission gears.

FIG. 2 is a top perspective view of the continuous magnetic drive.

FIG. 3 is an enlarged top view of the continuous magnetic drive to show the detail of the arrangement of the elements.

FIG. 4 is a top view of the core of the continuous magnetic drive.

FIG. 5 is a side perspective view of the core of the continuous magnetic drive.

FIG. 6 is a side perspective view of the rotor shaft within the core of the continuous magnetic drive.

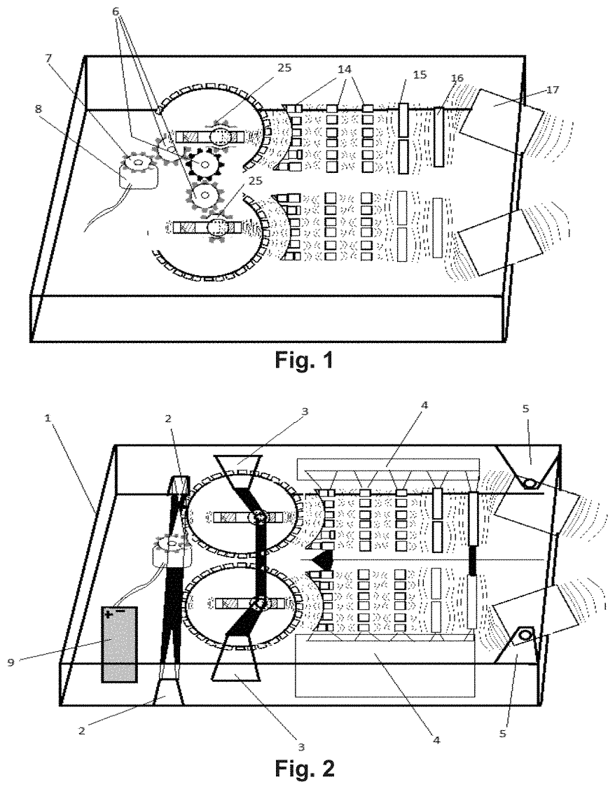

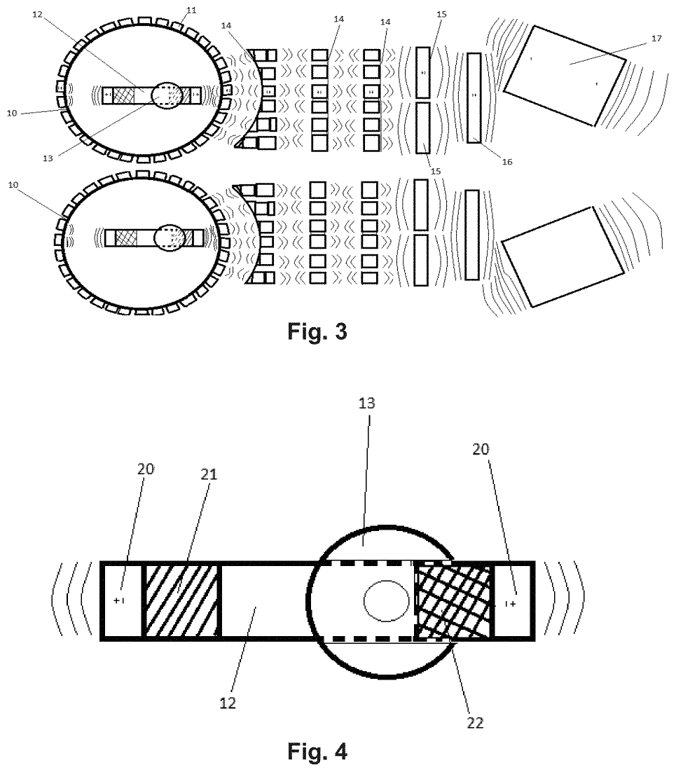

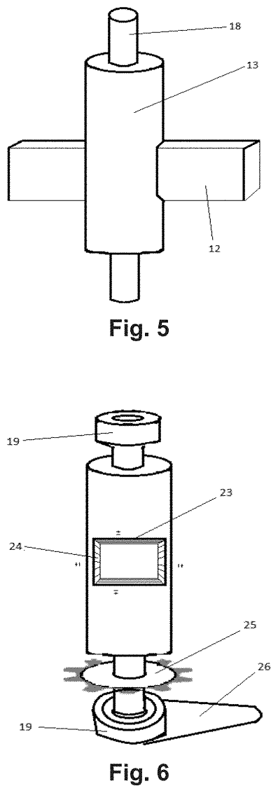

### DETAILED DESCRIPTION OF THE INVENTION

The continuous magnetic pulse thruster described in the present invention is made up of four sections: the first consists of the reaction-free magnetic pulse generator, the second is the receivers and dilators of the magnetic pulse (4, 14), the third is the magnetic pulse concentrator (4, 16) and the fourth are the magnetic pulse retainers (5, 17). This conformation achieves a magnetic pulse thruster capable of generating movement without it being supported by the environment and achieving linear continuity in the resultant force vector; so that its force and movement is capable of generating a negative reading when placed on a scale in a vertical position, that is to say, reduce its weight.

The continuous magnetic pulse thruster comprises a structure (1) that houses two cylinders (10) of diamagnetic material, fastened to the structure (1) by cylinder and motor supports (2) and cylinder and rotor shaft supports (3) that fix them to this.

Each of the two cylinders (10) of diamagnetic material comprises walls of a height slightly greater than the width of the cores (12), described later, and each of which is comprises magnets adhered to their surroundings (11), both Cylinders are located arranged one contiguous to the other and each one is crossed by an axis-rotor (13) in a perpendicular position to the circle that demarcates their perimeter and where each axis-rotor (13) is off-center with respect to the demarcated circle for each cylinder (10).

Both axes-rotors (13) are synchronized to rotate at the same time but in opposite directions; by means of an arrangement of transmission gears (6) that engages with both gears (25) fixed to the pivot of the rotor-shaft (18) that rotate within a bearing (19) held by a support (26), the arrangement of gears (6) also fit with an electric motor gear (7) that is connected to the electric motor (8) that is powered by a battery (9), each rotor shaft (13) has a cavity (23) in the center, which crosses it, said cavity (23) is covered by a thin sheet of magnet (24), and in said cavity a floating core (12) made of diamagnetic material is attached that crosses it and protrudes on both sides of the cavity (23) of the rotor-shaft (13), being able to slide freely horizontally within said cavity (23), in a perpendicular position with respect to the rotor-shaft (13).

Each of the two cores is hollow and is comprised inside by two core magnets (20) with opposite polarities to the magnets on the cylinder walls (11), the core magnets (20) are positioned at each end of the core, and adjacent to the core magnets (20), comprising: at one end, an element of diamagnetic heavy material (22) that fills part of the core, and at the other end, adjacent to the other magnet, an element of lightweight non-metallic material (21) that fills the remaining gap.

Said structure (1) houses, on the side where the axes-rotors (13) are closest to the perimeters of the two cylinders (10) and outside these, at a small distance, two groups of arrangements made up of various rows of receiving magnets and magnetic pulse dilators (14), which are aligned with the magnets on the walls of the cylinders (11) but with opposite polarities to the magnets on the walls of the cylinders (11), and in turn, between row and row of receiving magnets and magnetic pulse dilators (14), there are conflicting polarities.

Followed by these two groups of magnetic pulse receiver and expander magnet row arrangements (14), the structure (1) also houses another section of large magnets, called magnetic pulse concentrator magnets (15) and (16), these magnets magnetic pulse concentrators (15) and (16), also separated by a short distance and are each aligned with each group. The concentrating magnets of the magnetic pulse (15) and (16) concentrate the continuous magnetic pulse produced in the previous arrangement groups. The arrangements (14), (15) and (16) are attached to the structure (1) through supports (4).

Finally, followed at a short distance and in the same structure also aligned with the concentrating magnets of the magnetic pulse (15) and (16), a pair of larger magnets (17) are attached to the structure (1) by means of a support (5), positioned on the same line of action but rotated at an angle of 45 degrees with respect to the concentrating magnets of the magnetic pulse (15), which serve to retain the force of the continuous magnetic pulse, generated in order to move the structure of the system; without this movement being due to any other force other than that produced in the closed system itself.

1. A continuous magnetic pulse thruster, characterized in that it comprises four sections: the first section comprises a reaction-free magnetic pulse generator, the second comprises receivers and dilators of the magnetic pulse (4), the third comprises a concentrator of the magnetic pulse (4) and the fourth comprises magnetic pulse retainers (5).

2. The continuous magnetic pulse thruster, according to claim 1, characterized in that the first section comprises a structure (1) that houses two cylinders (10) of diamagnetic material, attached to the structure (1) by cylinder supports and of motor (2) and cylinder supports and axes-rotors (3) that fix them to it, where said both cylinders are located arranged one contiguous to the other and each one is crossed by a axis-rotor (13) in perpendicular position to the circle that demarcates the perimeter of these and where each axis-rotor (13) is off-center with respect to the circle demarcated by each cylinder (10), and where both axes-rotors (13) are synchronized to rotate at the same time but in opposite senses; by means of an arrangement of transmission gears (6) that engages with both gears (25) fixed to the pivot of the rotor-shaft (18) that rotate inside a bearing (19) held by a support (26), where the Gear arrangement (6) also fits with an electric motor gear (7) that is connected to the electric motor (8) that is powered by a battery (9), each rotor shaft (13) has a cavity (23) in the center, which crosses it, said cavity (23) is lined by a thin sheet of magnet (24), and in said cavity a floating core (12) made of diamagnetic material is attached that crosses it and protrudes on both sides of the cavity (23) of the rotor-shaft (13), being able to slide freely horizontally within said cavity (23), in a perpendicular position with respect to the rotor-axis (13).

3. The continuous magnetic pulse thruster, according to claim 1, characterized in that the second section comprises, within the structure (1), two groups of arrangements made up of several rows of receiving magnets and magnetic pulse dilators (14), these are aligned with the magnets on the cylinder walls (11) but with opposite polarities to the magnets on the cylinder walls (11), and in turn, between row and row of receiving magnets and magnetic pulse dilators (14) there are conflicting polarities.

4. The continuous magnetic pulse thruster, according to claim 1, characterized in that the third section comprises the structure (1) that also houses another section of large magnets, called magnetic pulse concentrating magnets (15) and (16), these concentrating magnets of the magnetic pulse (15) and (16), are separated by a short distance and are each aligned with each group. The concentrating magnets of the magnetic pulse (15) and (16) concentrate the continuous magnetic pulse produced in the previous arrangement groups. The arrangements (14), (15) and (16) are attached to the structure (1) through supports (4).

5. The continuous magnetic pulse thruster, according to claim 1, characterized in that the third section comprises, at a short distance and in the same structure (1), also aligned with the concentrating magnets of the magnetic pulse (15) and (16) and fastened by means of a support (5) to the structure (1), a pair of larger magnets (17), positioned on the same line of action; but rotated at an angle of 45 degrees with respect to the concentrating magnets of the magnetic pulse (15), which serve to retain the force of the continuous magnetic pulse, generated in order to move the structure of the system; without this movement being due to any other force other than that produced in the closed system itself.
